(19) United States
(12) Patent Application Publication
(10) Pub. No.: US 2024/0178435 A1
(43) Pub. Date: May 30, 2024

(54) ELECTROCHEMICAL CELL AND METHOD FOR PRODUCING AN ELECTROCHEMICAL CELL

(71) Applicant: Manz AG, Reutlingen (DE)

(72) Inventor: Patrick KIRSCHBAUM, Reutlingen (DE)

(73) Assignee: Manz AG, Reutlingen (DE)

(21) Appl. No.: 18/519,390

(22) Filed: Nov. 27, 2023

(30) Foreign Application Priority Data
Nov. 28, 2022 (EP) 22209857.6

(51) Int. Cl. H01M 10/04; H01M 4/70; H01M 50/107; H01M 50/152; H01M 50/533; H01M 50/538; H01M 50/627

(52) U.S. Cl. CPC H01M 10/0431; H01M 4/70; H01M 50/107; H01M 50/152; H01M 50/533; H01M 50/538; H01M 50/627

(57) ABSTRACT

An electrochemical cell has an electrode coil, including a first and a second electrode, wherein at least one electrode has tabs, of which at least some are bent over at a first end face of the electrode coil and are electrically conductively connected to a current collector, wherein at least one surface region which is free of tabs is provided on the first end face of the electrode coil, and the current collector has an electrolyte filling opening which is arranged in the region of the at least one surface region which is free of tabs.

### CROSS REFERENCE TO RELATED APPLICATIONS

Applicant claims priority under 35 U.S.C. § 119 of European Application No. 22209857.6 filed Nov. 28, 2022, the disclosure of which is incorporated by reference.

### BACKGROUND OF THE INVENTION

### 1. Field of the Invention

The invention relates to an electrochemical cell having an electrode coil, comprising a first and a second electrode, at least one electrode having tabs, of which at least some are bent over at a first end face of the electrochemical cell and are electrically conductively connected to a current collector.

The invention further relates to a method for producing an electrochemical cell.

### 2. Description of the Related Art

To date, it is known to produce a cylindrically wound electrochemical cell in that tabs are formed on an electrode strip by removing portions of the edge region of the electrode strip. After winding the electrode strip into an electrode coil, the tabs are rolled, crimped or compacted over the entire surface. The end face of the electrode coil is thereby almost completely sealed. As a result, electrolyte can penetrate into the electrode coil only very slowly. The production process of an electrochemical cell is thereby considerably slowed down.

### SUMMARY OF THE INVENTION

The object of the present invention is therefore to provide an electrochemical cell which can be produced significantly faster, in which in particular the filling with electrolyte can take place more quickly.

This object is achieved according to the invention by an electrochemical cell having an electrode coil, comprising a first and a second electrode, at least one electrode having tabs, of which at least some are bent over at a first end face of the electrode coil and are electrically conductively connected to a current collector, at least one surface region that is free of tabs being provided on the first end face of the electrode coil, and the current collector having an electrolyte filling opening which is arranged in the region of the at least one surface region that is free of tabs. Due to the fact that a surface region free of tabs is provided, electrolyte can penetrate more quickly into the electrode coil at this point. In particular, no sealing or caulking of the electrode coil takes place in the surface regions that are free of tabs. The electrochemical cell can thus be filled with electrolyte much more quickly than was previously possible. Due to the fact that the electrolyte filling opening of the current collector is arranged in the region of the surface region that is free of tabs, excessive lateral movement of the electrolyte is also not necessary in order to be able to reach all regions of the electrode coil. Surface regions with and without tabs can be formed on the two opposite end faces of the electrode coil. In particular, the electrode coil can be designed symmetrically with respect to a central transverse plane. If regions that are free of tabs are also provided on the second end face, electrolyte can be poured in at the first end face, pass through the electrode coil to the second end face, and can be sucked up from the second end face, through the regions that are free of tabs, by the electrode coil. The filling with electrolyte can take place under pressure, possibly in multiple pressure cycles.

The electrochemical cell can be designed as a primary cell (battery) or secondary cell (accumulator). Alternatively, the electrochemical cell can be designed as a capacitor.

The electrolyte filling opening is preferably arranged above the electrodes in a region free of tabs. It is particularly preferably arranged so as to be radially spaced apart from a central longitudinal axis of the electrode coil or from a core of the electrode coil. The electrode coil is usually wound around a central core. The central core is also free of tabs, but there is no electrode there. The at least one region of the electrode coil that is free of tabs, in which region an electrode is also arranged, thus begins at a certain radial distance from the central longitudinal axis of the electrode coil. Accordingly, it is advantageous if the electrolyte filling opening is also spaced radially from the central longitudinal axis so that it is arranged above the electrodes in a region that is free of tabs.

It is conceivable that the current collector additionally has a central electrolyte filling opening, from which electrolyte is distributed. The central electrolyte filling opening can communicate with an electrolyte filling opening in a cover.

On the first end face of the electrode coil, multiple surface regions that are free of tabs can be provided, and the current collector can have multiple electrolyte filling openings which are each arranged in the region of a surface region that is free of tabs. The electrolyte filling can thereby be accelerated.

The at least one surface region that is free of tabs can extend up to the radially outer edge of the electrode coil. It can thereby be ensured that the electrode coil is impregnated with electrolyte over its entire radial extension.

It is particularly advantageous if the distance between the tabs and/or between groups of tabs increases in a direction of the unwound electrode coil. In particular, the distance between the tabs and/or between groups of tabs can increase progressively in the direction of the unwound electrode coil, i.e., of the electrode strip before winding. As a result, the surface regions that are free of tabs can be produced on the end face of the electrode coil in a particularly simple manner.

Alternatively or additionally, it can be provided that the width of the tabs and/or of groups of tabs increases in a direction of the unwound electrode coil. It can thus be achieved, for example, that the regions of the end face which have tabs are designed in the shape of a circle segment. The same applies to the distance between the tabs or between groups of tabs. Due to the increasing distance, it can be achieved that the surface regions that are free of tabs are designed in the shape of circle segments.

The distance between tabs and/or groups of tabs can be constant in a longitudinal portion of the unwound electrode coil corresponding to one winding. The above-described increase in the distance between the tabs and/or groups of tabs can thus take place from length portion to length portion.

Alternatively or additionally, it can be provided that the width of the tabs and/or groups of tabs is constant in a longitudinal portion of the unwound electrode coil corresponding to one winding. Here, too, it is the case that the above-described increase in the width can increase from length portion to the length portion.

Tabs can be arranged at the top and bottom on the electrode coil. In this case, the tabs at one end of the electrode coil can be assigned to a first electrode, and the tabs at the other end of the electrode coil can be assigned to the other electrode. A separator can be provided between the electrodes. Tabs on opposite sides or edges of the unwound electrode coil can be arranged opposite or offset from one another. The tabs on opposite edges of the unwound electrode coil can be of the same width or different widths.

The current collector can be welded to tabs in a surface region of the first end face having tabs, the surface area of the weld being smaller than the surface region having the tabs. It can thereby be ensured that welding is not carried out next to the tabs. The welding can take place in particular by means of a laser. If the weld itself is smaller than the surface region having the tabs, there is a greater tolerance in the positioning of the current collector on the end face of the electrode coil.

The current collector may be designed to be discoid. The current collector, in particular a current collector disk, can be welded to the housing. The housing can additionally have a cover.

The diameter of the current collector can correspond approximately to the diameter of the electrode coil. The end face can thus be completely covered by the current collector. It can thereby be ensured that sufficiently large surfaces are available for welding to the tabs.

At least one surface region that is free of tabs can be provided on the second end face of the electrode coil. The electrolyte can thereby also pass into the electrode coil from below.

The surface regions of the first end face that are free of tabs and the surface regions of the first end face which have the tabs can be of approximately the same size. In particular, overall the surface region that comprises tabs can correspond to the surface area of the surface regions that do not have tabs. Regions with and without tabs can alternate in the peripheral direction or radially. A good and extensive support of the current collector, in particular when this is of discoid design, can thereby be ensured.

The electrode coil can be arranged in a housing, and the current collector can be connected, in particular welded, to the housing, in particular in a fluid-tight manner. It can thereby be ensured that electrolyte does not leave the housing.

The invention also relates to a method for producing an electrochemical cell, in particular an electrochemical cell according to the invention, comprising the method steps of:
a. producing an electrode strip
b. forming tabs on an edge of the electrode strip,
i. the distance between tabs and/or between groups of tabs increasing in a direction of the electrode strip and/or
ii. the width of the tabs and/or of groups of tabs increasing in a direction of the electrode strip,
c. winding the electrode strip into an electrode coil
d. arranging a current collector on a first end face of the electrode coil such that an electrolyte filling opening of the current collector is arranged in a surface region that is free of tabs,
e. welding the current collector to at least some tabs.

The tabs can be formed by removing electrode material at the upper and/or lower edge of the electrode strip. This can be done, for example, by means of a laser or by punching. The electrochemical cell can be designed as a primary cell or secondary cell. Alternatively, the electrochemical cell can be designed as a capacitor. In this case, the separator is preferably designed as a dielectric. The electrode coil can therefore in particular be produced in such a way that electrode material is applied to both sides of a separator strip or a separator film or membrane. In this case, the electrodes can be offset such that one electrode projects beyond the separator at the upper edge of the electrode strip and the other electrode projects beyond the separator at the lower edge of the electrode strip. The electrode strip is then wound up.

Due to the fact that the distance between tabs and/or groups of tabs is varied and/or the width of the tabs and/or of groups of tabs is varied, surface regions can be created on the end face of the electrode coil, at least on one end face, which comprise tabs, and surface regions which do not have any tabs. In the regions which do not have any tabs, electrolyte can be introduced particularly easily into the electrode coil.

Before welding the current collector to the tabs, the tabs can be bent. This can be done, for example, by crimping. Electrolyte can be poured through an electrolyte filling opening of the current collector. The electrolyte filling opening of the current collector is preferably positioned such that it is located above a region which does not have any tabs. Multiple electrolyte filling openings can be provided.

Particular advantages result if the distance between tabs or groups of tabs and/or the width of tabs and/or groups of tabs is set taking into account a detected size and/or shape of at least one surface region free of tabs and/or at least one surface region comprising tabs, of the end face of a previously manufactured electrochemical cell. An adjustment of the distance or the width can take place in particular when it is determined that the size and/or shape deviates from a predetermined size and/or shape by more than a prespecified amount. This measure ensures a uniform quality of the electrochemical cells produced.

According to a method variant, the size and/or shape of at least one surface region of the end face that is free of tabs, and/or at least one surface region comprising tabs can be detected. In particular, the detection can take place optically, for example by means of a camera.

Electrolyte can be poured in at the first end face of the electrode coil, in particular through an electrolyte filling opening of the current collector and optionally of a cover. The electrode coil can be evacuated beforehand, i.e., a negative pressure can be applied. The filling with electrolyte can take place under pressure, possibly in multiple pressure cycles. Electrolyte can reach the second end face in the region of the core or through the electrode coil and can be sucked up by a surface region that is free of tabs on the second end face. A rapid and complete filling can thereby be achieved.

### BRIEF DESCRIPTION OF THE DRAWINGS

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

FIG. 1 shows a highly schematic view of an electrochemical cell;

FIG. 2 shows a plan view of the end face of an electrode coil;

FIG. 3 shows a first embodiment of an unwound electrode coil;

FIG. 4 shows a second embodiment of an unwound electrode coil;

FIG. 5 shows a further embodiment of an unwound electrode coil;

FIG. 6 shows a plan view of the end face of an electrode coil, welds being indicated;

FIG. 7 shows the plan view of a current collector which is welded to the tabs of an electrode coil.

### DETAILED DESCRIPTION OF PREFERRED EMBODIMENTS

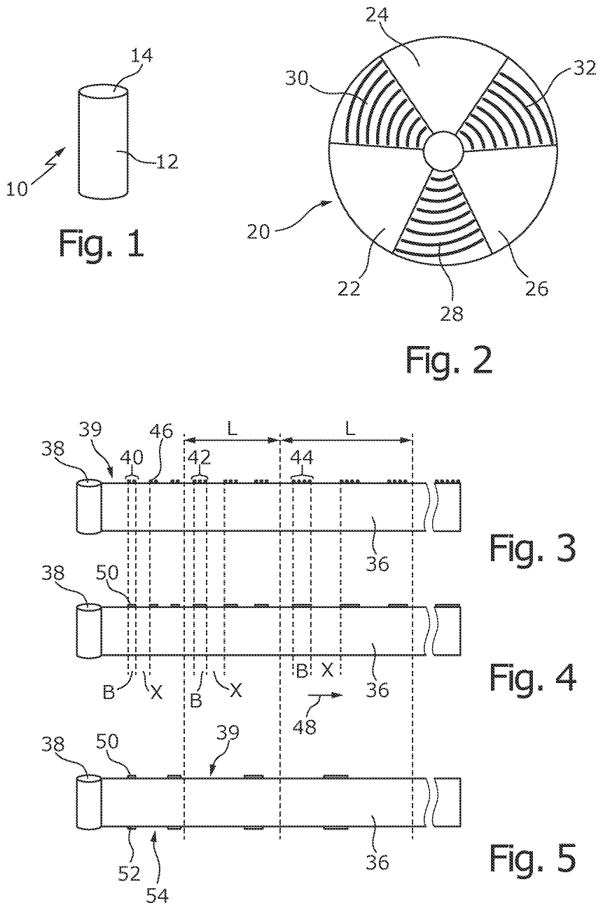

FIG. 1 shows an electrochemical cell 10 which is designed as a cylindrical electrochemical cell. The electrochemical cell 10 has a housing 12 in which an electrode coil (not shown here) is arranged. Furthermore, electrolyte is provided in the electrochemical cell 10. The electrochemical cell 10 is closed by a current collector 14, which can also constitute a cover.

FIG. 2 shows a plan view of an end face (upper side or lower side) of an electrode coil 20. Three circle segment shaped surface regions 22, 24, 26 are provided in the present embodiment, which comprise tabs. The tabs represent the electrical contact with an electrode of the electrode coil 20. Surface regions 28, 30, 32 that are free of tabs are arranged between the surface regions 22, 24, 26. In these regions, electrolyte can be introduced into the electrode coil 20. In the embodiment shown, the surface regions 22, 24, 26 are designed to be approximately of the same size as the surface regions 28, 30, 32 that are free of tabs. Thus, the surface portion of the end-face surface having tabs corresponds approximately to the surface portion of the surface regions 28, 30, 32 that are free of tabs. In the embodiment shown, the surface regions 28, 30, 32 that are free of tabs start at a core 38, i.e., radially somewhat spaced from a central longitudinal axis, and extend as far as the radially outer edge of the electrode coil 20.

FIG. 3 shows an electrode strip 36 which corresponds to an unwinding of the electrode coil 20. A core 38, around which the electrode strip 36 can be wound, can be seen at the left-hand end of the electrode strip 36. In an upper edge region 39, the electrode strip 36 has groups 40, 42, 44 of tabs 46. The distance X between the groups 40, 42, 44 of tabs 46 increases in the arrow direction 48, in particular increases progressively.

The width B of the groups 40, 42, 44 of tabs 46 also increases in the arrow direction 48. It should be noted that, in the embodiment shown, both the distance X and the width B remain constant within a length portion L, the length portions L each corresponding to a winding when the electrode strip 36 is wound up to form the electrode coil 20.

FIG. 4 differs from FIG. 3 only in that no groups 40, 42, 44 of tabs 46 are provided, but rather tabs 50 of which the width B increases in the arrow direction 48. In addition, the distance X between two tabs 50 increases in the arrow direction 48. Here, too, it is the case that the distance X and the width B are constant for a length portion L corresponding to a winding.

On the basis of the embodiment according to FIG. 5, it is to be shown that tabs 50 can be provided not only in an upper edge region 39, but rather that tabs 52 can also be provided in a lower edge region 54 of the electrode strip 36. In this case, the tabs 52 are associated with a different electrode compared with the tabs 50.

If the tabs 46, 50, 52 are bent over after winding of the electrode strip 36 to form an electrode coil, the surface regions 22, 24, 26, 28, 30, 32 according to FIG. 2 arise due to the width and the distance between the tabs 46, 50, 52.

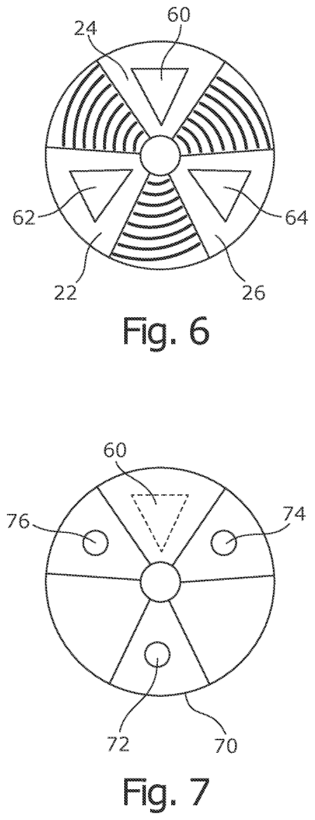

FIG. 6 shows a representation corresponding to FIG. 2, a weld 60 additionally being shown here. At the weld 60, the tabs of the surface region 24 are welded to a current collector. Corresponding welds 62, 64 are also provided for the other surface regions 22, 24. It can be seen that the welds 60, 62, 64 are smaller in area than the surface regions 22, 24, 26. It can thereby be ensured that welding is not performed outside of the surface regions 22, 24, 26 and there is a greater tolerance with regard to the positioning of the current collector.

FIG. 7 is a plan view of a current collector 70 which was welded to the tabs in the surface regions 22, 24, 26. The weld 60 is indicated by way of example. It can be seen that the current collector 70 has electrolyte filling openings 72, 74, 76, through which electrolyte can be poured into the electrochemical cell. The electrolyte filling openings 72, 74, 76 are positioned above the surface regions 28, 30, 32 that are free of tabs (see FIG. 2). The electrolyte filling openings 72, 74, 76 are arranged so as to be radially spaced apart from a central longitudinal axis. A central electrolyte filling opening, which is positioned in the region of the core 38, can also be seen.

The design and number of surface regions 22 to 32 and their shape is merely by way of example. There are numerous possible variations here. Preferably, the surface regions 30, 32, 28 that are free of tabs are arranged peripherally or radially alternately with the surface regions 22, 24, 26 which have tabs.

This results in sufficient possibilities for welding the current collector 70, which can be designed to be discoid, to the tabs. At the same time, sufficient free surfaces exist through which electrolyte can be poured into the electrochemical cell 10.

1: An electrochemical cell (10) having an electrode coil (20), comprising a first and a second electrode, at least one of said electrodes having tabs (46, 50, 52), wherein at least some of the tabs are bent over at a first end face of the electrode coil (20) and are electrically conductively connected to a current collector (70), wherein at least one surface region (28, 30, 32) that is free of tabs is provided on the first end face of the electrode coil (20), and the current collector (70) has an electrolyte filling opening (72, 74, 76) which is arranged in a region of the at least one surface region (28, 30, 32) that is free of tabs.

2: The electrochemical cell according to claim 1, wherein the electrolyte filling opening (72, 74, 76) is arranged so as to be radially spaced apart from a central longitudinal axis of the electrode coil (20).

3: The electrochemical cell according to claim 1, wherein multiple surface regions (28, 30, 32) which are free of tabs are provided on the first end face of the electrode coil (20), and the current collector (70) has multiple electrolyte filling openings (72, 74, 76) which are each arranged in the region of a surface region (28, 30, 32) that is free of tabs.

4: The electrochemical cell according to claim 1, wherein the at least one surface region (28, 30, 32) that is free of tabs extends as far as a radially outer edge of the electrode coil (20).

5: The electrochemical cell according to claim 1, wherein the distance (X) between tabs (46, 50, 52) and/or between groups (40, 42, 44) of tabs (46, 50, 52) increases in a direction of the unwound electrode coil (20).

6: The electrochemical cell according to claim 1, wherein a width (B) of the tabs (46, 50, 52) and/or of groups (40, 42, 44) of tabs (46, 50, 52) increases in a direction of the unwound electrode coil (20).

7: The electrochemical cell according to claim 1, wherein the distance (X) between tabs (46, 50, 52) and/or groups (40, 42, 44) of tabs (46, 50, 52) is constant in a length portion (L) of the unwound electrode coil (20) corresponding to one winding.

8: The electrochemical cell according to claim 1, wherein a width (B) of the tabs (46, 50, 52) and/or of groups (40, 42, 44) of tabs (46, 50, 52) is constant in a length portion (L) of the unwound electrode coil (20) corresponding to one winding.

9: The electrochemical cell according to claim 1, wherein the current collector (70) is welded to the tabs (46, 50, 52) in a surface region (22, 24, 26) of the first end face which has tabs (46, 50, 52), wherein a surface of the weld (60, 62, 64) is smaller than the surface region (22, 24, 26) having the tabs (46, 50, 52).

10: The electrochemical cell according to claim 1, wherein the current collector (70) is discoid.

11: The electrochemical cell according to claim 1, wherein a diameter of the current collector (70) corresponds approximately to a diameter of the electrode coil (20).

12: The electrochemical cell according to claim 1, wherein at least one surface region (28, 30, 32) that is free of tabs is provided on a second end face of the electrode coil (20).

13: The electrochemical cell according to claim 1, wherein the surface regions (28, 30, 32) free of tabs, of the first end face, and surface regions (22, 24, 26) of the first end face having the tabs (46, 50, 52) are of approximately the same size.

14: The electrochemical cell according to claim 1, wherein the electrode coil (20) is arranged in a housing (12) and the current collector (70) is connected to the housing.

15: A method for producing an electrochemical cell, having the method steps of:
a. producing an electrode strip (36),
b. forming tabs (46, 50, 52) at an edge (39, 54) of the electrode strip (36), wherein
i. a distance (X) between tabs (46, 50, 52) and/or between groups (40, 42, 44) of tabs (46, 50, 52) increases in a direction of the electrode strip (36), and/or
ii. a width (B) of the tabs (46, 50, 52) and/or of groups (40, 42, 44) of tabs (46, 50, 52) increases in a direction of the electrode strip (36),
c. winding the electrode strip (36) into an electrode coil (20),
d. arranging a current collector (70) on a first end face of the electrode coil (20), such that an electrolyte filling opening (72, 74, 76) of the current collector (70) is arranged in a surface region (28, 30, 32) which is free of tabs, and
e. welding the current collector (70) to at least some tabs (46, 50, 52).

16: The method according to claim 15, wherein
a. the distance between tabs (46, 50, 52) or groups (40, 42, 44) of tabs (46, 50, 52), and/or
b. the width of tabs (46, 50, 52) and/or groups (40, 42, 44) of tabs (46, 50, 52) is set taking into account a detected size and/or shape of at least one surface region (28, 30, 32) that is free of tabs and/or at least one surface region (22, 24, 26) having tabs (28, 30, 32), of the end face of a previously manufactured electrochemical cell (10).

17: The method according to claim 15, wherein the size and/or shape of at least one surface region (28, 30, 32) that is free of tabs (28, 30, 32) and/or at least one surface region (28, 30, 32) having tabs (46, 50, 52) is detected, in particular optically.

18: The method according to claim 15, wherein electrolyte is poured in at the first end face of the electrode coil (20) and is sucked up by a surface region that is free of tabs, on a second end face.
